(19) United States
(12) Patent Application Publication
(10) Pub. No.: US 2005/0039793 A1
(43) Pub. Date: Feb. 24, 2005

(54) Device for introducing substances into water

(76) Inventors: Sam Zhadanov, Brooklyn, NY (US); Eli Zhadanov, Brooklyn, NY (US)

Correspondence Address: Ilya Zborovsky, 6 Schoolhouse Way, Dix Hils, NY, 11746, US

(21) Appl. No.: 10/050,191

(22) Filed: Jan. 16, 2002

(51) Int. Cl. F17D 1/00

(52) U.S. Cl. 137/268

(57) ABSTRACT

A device for introducing substances into water has a substantially tubular element connectable to a water passage and also connectable to a container which stores a substance so that the supplied water can be reached with the substance and supplied to a consumer, and a connecting element for connecting the tubular element to the water passage in a predetermined position of the device desired by a user.

### BACKGROUND OF THE INVENTION

The present invention relates to devices for introducing substances into water.

Devices of the above mentioned general type are known in the art. Some of such devices are disclosed in our U.S. Pat. Nos. 5,730,178; 6,187,186; 6,176,253. The known devices, usually include a structural element for supplying water and attachable to a water source, a substance storing container, means connecting the structural element with the container to introduce water into it to be enriched with the substance and then to supply the enriched water further, etc. It is believed that the existing devices can be further improved. In particular, when a container with a substance is attached to the tubular element of the device, it is important to install the thusly assembled device in a certain position on a water passage. Also further improvements are desirable.

### SUMMARY OF THE INVENTION

Accordingly, it is an object of the present invention to provide a device for introducing substances into water, which is a further improvement of the existing devices.

In keeping with these objects and with others which will become apparent hereinafter, one feature of present invention resides, briefly stated, in a device for introducing substances into water which has a substantially tubular element connectable to a water passage and also connectable to a container for storing a substance to be introduced into water, wherein means are provided for connecting the tubular element to the water passage so that the tubular element can be retained in a desired position, for example with the container mounted independently from it, while at the same time it can be connected to the water passage independently on the position of the tubular element with the container.

In accordance with a further feature of the present invention, the connecting means is formed as a tubular connector which has a first portion which is freely rotatably mounted on the tubular element, and a second portion which is axially spaced from the first portion and is provided with connecting means, for example a thread attachable to the water passage.

In accordance with another feature of the present invention, the ends of the tubular element are formed so that each of the ends can be alternatingly connected to a water issuing element and to a water supplying element, depending on how the tubular element is turned around.

When the device is designed in accordance with the present invention, it provides simple and efficient operation, in particular a connection to the water passage, a good distribution of water, and reliable sealing of the device.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a device for introduction of substances into water in accordance with the present invention;

FIG. 2 is a view showing connecting means for connecting a device to a water source for example a water pipe;

FIG. 3 is a view showing a further embodiment of the inventive device for introduction of substances into water; and

FIGS. 4 and 5 are views showing two further embodiments of the inventive device for introduction of substances into water.

### DESCRIPTION OF THE PREFERRED EMBODIMENTS

A device for introducing substances into water has a housing which is identified with reference numeral 1 and has a tubular portion 2 provided with an inner through going opening 3.

The device further has a flange part which is identified with reference numeral 4 and is turnable relative to the housing between open and closed positions. A container 5 provided with a substance to be introduced into water and attachable to the flange, for example by a thread.

The housing 1 has a partition 6 with a narrow hole 7, for forming two chambers 8 and 9. The housing has two holes 10 and 11, while the flange has two holes 12 and 13.

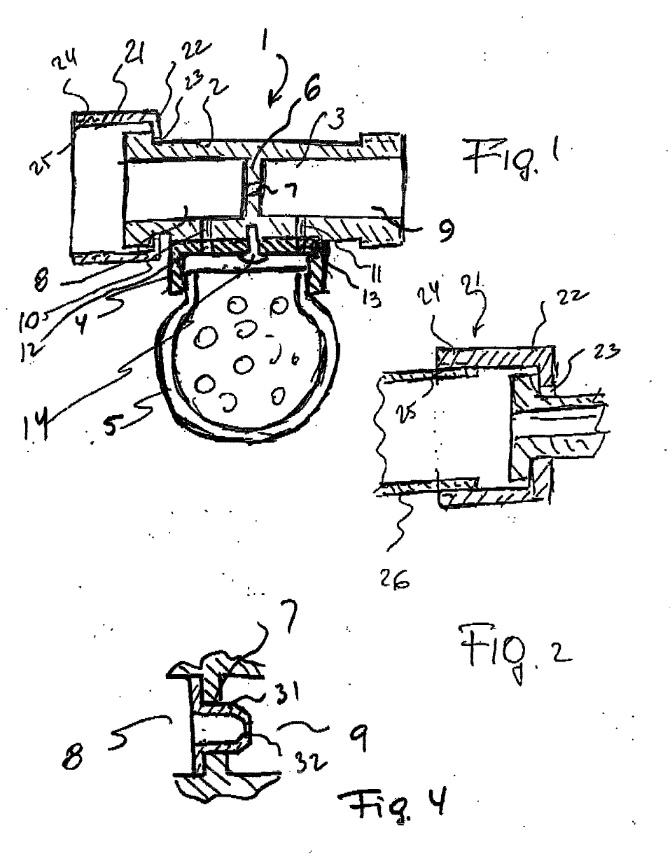

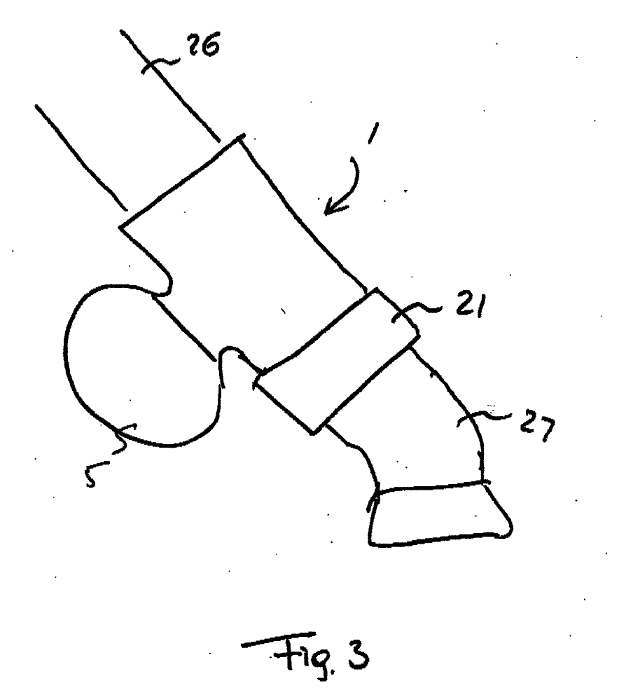

During the operation water flows in the open position of the flange shown in FIG. 1, water flows from the water source into the chamber 8 and then through the aligned openings 10 and 12 into the container. When the water is enriched with the substance from the container, it then flows back container through the aligned openings 13 and 11 into the chamber 9 and to the consumer.

When the flange is turned around the pin 12 to a closed position the water does not flow to the consumer.

In accordance with a very important feature of present invention, the device is provided with means for attaching it to a water passage in a desired, predetermined position. Usually the washing devices of this type have a connecting thread with which they are screwed on a water supplying pipe. When the thread of the device is tightened on the thread of the pipe, the device remains in any position around the axis of the water pipe, depending on the corresponding parameters of the two threads. However it is desirable to arrange the device in a predetermined position, for example so that the container which contains the substance to be introduced into water is located strictly vertically under the tubular element.

For this purpose special connecting unit is provided in the inventive device. The connecting unit is formed as a ring-shaped element which is identified as a whole with reference numeral 21. The connecting element 21 has a first axial portion 22 which is rotatably connected to a portion of the tubular element. For this purpose, the portion 22 has an inner opening 23 with a diameter which is somewhat greater than the diameter of the corresponding portion of the tubular element. The axial portion 22 is located behind a flange of the tubular element.

The connecting element 21 further has another axial portion 24 which is axially spaced from the portion 22. The portion 24 is provided with connecting means 25 for connecting the portion 24 to a water source, for example a water pipe 26. The connecting means 25 can be formed for example as a thread. This can be seen from the drawings. The connecting means 25 of the portion 24 is axially spaced from the opening 23 of the portion 22.

The device is connected to a water source, for example the water pipe 26 in the following manner.

The user holds the tubular element so that the container 7 is located underneath the tubular element, with one hand, and at the same time turns the connecting element 21 with another head so that the thread 25 is screwed onto the corresponding thread of the water pipe 26. When the connecting element 21 is completely tightened on the pipe, the mounting is finished, and the tubular element is retained in the desired position, in which the container 7 is located vertically underneath the tubular element.

As shown in FIG. 1, the connecting means connect the device to a water passage which in this embodiment is a water supplying pipe 26. FIG. 3 shows a further embodiment of the invention. Here the housing 1 of the device is connected to the water source 26 fixedly, while the ring-shaped element 21 of the connecting unit connects the housing 1 to a device of a hand shower 27 in the same manner, in particular so that it is possible to turn the shower head 27 relative to the device or the device relative to the shower head and to fix them in any position relative to one another, for example so as to hold the container in the desired position.

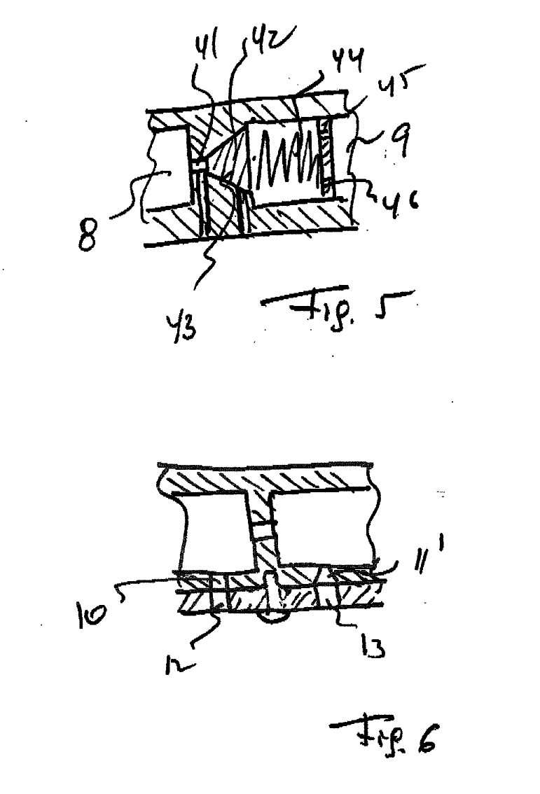

FIG. 4 shows a further embodiment of the present invention. In this embodiment the control member 31 is arranged in the whole 7 of the partition 6. It can be formed for example as a diaphragm. When water flows through an opening of the diaphragm from the control member. FIG. 6 is provided so that a pressure difference is introduced between the first chamber 8 and the second chamber 9. The difference depends on the size of the opening 32 in the diaphragm. A flow rate and concentration of the solution from the container depends from the pressure difference between the chambers. Since water systems having various pressures, the pressure difference between the chambers can very significantly if the opening in the partition between the chambers is constant, and at low pressures the pressure difference can drop to zero so that there can be no supply of the solution, while in conditions of high pressure difference the solution will be immediately washed out from the container. The diaphragm 31 is composed of elastic material, for example rubber and its hardness is selected to control the pressure difference. When there is a high water supply pressure, the openings 32 of the diaphragms opens so as to increase a water flow rate, while the condition of all water supply pressure the openings 32 of the diaphragm narrows so as to maintain the pressure difference.

FIG. 5 shows a further embodiment of the present invention. Here the opening between the chambers 8 and 9 has a cylindrical portion 41 and a conical portion 42. The control member 43 is arranged in the conical opening 42 and is spring biased by, a spring 44. A perforated further partition 45 is provided with two openings 46. When water enriched the substance flows through the opening through the partition, the control member 43 which is formed as a conical member deviates from the conical opening portion 42 to form a gap therebetween to allow water to flow from the chamber 8 into the chamber 9 and thereafter through the openings 46 of the partition 45, while the solution of the water with the substance flows from the container through the corresponding aligned openings. In the event of a back pressure, a control member is firmly pressed against the conical opening portion. As a result the solution can not flow back into the chamber 8 from the chamber 9, nor from the container.

In accordance with a further feature of the present invention shown in FIG. 6, the second hole 11′ in the housing is formed as a conical hole narrowing toward the outlet. As a result, the water which is enriched with the washing solution in the container is introduced into the water outlet to form a high speed jet.

It will be understood that each of the elements described above, or two or more together, may also find a useful application in other types of 10 constructions differing from the types described above.

While the invention has been illustrated and described as embodied in device for introducing substances into water, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A device for introducing substances into water, comprising a substantially tubular element connectable to a water passage and also connectable to a container which stores a substance so that the supplied water can be with the substance and supplied to a consumer; and means for connecting said tubular element to the water passage in a predetermined position desired by a user, said connecting means including a connecting element connected to said tubular element and connectable to the water passage such that the device can be turned around an axis of said tubular element to occupy any desired position around the axis and said connecting element thereafter can be tightened to the water passage.

2. A device as defined in claim 1, wherein said connecting element has a first portion which is rotatably mountable on said tubular element, and a second portion which is axially spaced from said first portion and is provided with connecting means connectable to the water passage, so that said tubular element can be held by a user in a predetermined position, while said connecting element can be moved relative to the water passage to be connected with a water passage.

3. A device as defined in claim 2, wherein said first portion of said connecting element has an opening with a diameter which is substantially greater than an outer diameter of said tubular element, said connecting means of said second portion being formed as a thread which is screwable on the water passage.

4. A device as defined in claim 1, wherein said connecting means is formed so that said connecting element connected to said tubular element is connectable to the water passage formed as a water supplying pipe.

5. A device as defined in claim 1, wherein said connecting means is formed so that said connecting element connected to said tubular element is connectable to the water passage formed as a water issuing element.

6. A device as defined in claim 1, wherein said substantially tubular element has a central opening with a partition having a hole and separating said central opening into two chambers and also has a housing provided with two openings and a flange connectable to the container and provided with two further openings wherein said flange is turnable between an opening position in which said pairs of the openings communicate with one another, and the closed position to not communicate with one another, so that an open position water flows from one of the chambers through the line openings into the container is enriched with the substance and flows through the other two openings to the outlet.

7. A device as defined in claim 6; and further comprising a control member arranged so as to control a pressure in said chambers.

8. A device as defined in claim 7, wherein said control member is formed as an elastic diaphragm provided with a diaphragm opening.

9. A device as defined in claim 1, wherein said tubular element has two opposite ends each alternatingly connectable to both a water issuing element and a water supplying element, so that each of said ends can be connected to the water issuing element or to the water supplying element.
